(19) United States
(12) Patent Application Publication
(10) Pub. No.: US 2025/0129852 A1
(43) Pub. Date: Apr. 24, 2025

(54) SECONDARY SEAL ON A SAFETY VALVE

(71) Applicant: Dresser, LLC, Houston, TX (US)

(72) Inventor: Rajesh Krithivasan, Jacksonville, FL (US)

(21) Appl. No.: 18/917,907

(22) Filed: Oct. 16, 2024

Related U.S. Application Data
(60) Provisional application No. 63/591,143, filed on Oct. 18, 2023.

(51) Int. Cl. F16K 1/46

(52) U.S. Cl. CPC F16K 1/46

(57) ABSTRACT

A closure member is configured to avoid or reduce leak rates on a safety valve. These configurations may include a primary seal and a secondary seal, the combination of which may significantly reduce the amount of flow that exits the device. The secondary seal may embody a resilient member, like a bent or pleated metal spring. This resilient member may compress and extend in response to presence or absence of a load. This feature can maintain contact between the resilient member and the seat of the valve.

### CROSS-REFERENCE TO RELATED APPLICATIONS

This application claims the benefit of U.S. Ser. No. 63/591,143, filed on Oct. 18, 2023, and entitled “SECONDARY SEAL ON A SAFETY VALVE.” The content of this application is incorporated by reference herein in its entirety.

### BACKGROUND

Flow controls play a significant role in many industrial settings. Power plants and industrial process facilities, for example, use different types of flow controls to manage flow of material, typically fluids, throughout vast networks of pipes, tanks, generators, and other equipment. Safety relief valves are “fail-safe” devices that protect against rapid increases in pressure on the lines in these networks. Also known as “safety” valves, or “pressure relief” valves, these devices are necessary to avoid “overpressure” conditions that can cause damage to equipment or parts of facilities.

Safety valves may use different mechanisms to generate a closing or “biasing” force to maintain its closure member in contact with its seat. The resulting seal in this “seating area” prevents flow of material, unless a spike in system pressure occurs that overcomes the “set point” to open the valve. Pilot-operated safety relief valves (POSRVs) use system fluid, often under control of a fluid control module, to trigger operation as between its closed position and its open position. In other devices, coil springs and like devices may generate the biasing load. It has been found, though, that material may still leak through the seal at the seating area, even in response to system pressure that is actually below the set point for the device. Likewise, a material's density or other properties may also cause or exacerbate leaks. Compressible fluids may leak more than incompressible fluids, for example, because compressible fluids have a lower density than incompressible fluids.

### SUMMARY

The subject matter of this disclosure relates to improvements to flow controls. Of particular interest are embodiments that can prevent or capture material that leaks from the seating area of the device. These embodiments may incorporate an additional seal that resides outside, or circumscribes, a “primary” seal that the closure member forms with the seat. This additional seal will stop flow of material that may transit the primary seal at system pressure at or near the set point.

### DRAWINGS

This specification refers to the following drawings:

FIG. 1 depicts an exemplary embodiment of a closure member for use in a safety valve;

FIG. 2 depicts an example of structure for the closure member of FIG. 1;

FIG. 3 depicts an example of structure for the closure member of FIG. 1;

FIG. 4 depicts an example of structure for the closure member of FIG. 3;

FIG. 5 depicts an example of structure for the closure member of FIG. 3; and

FIG. 6 depicts a perspective view of exemplary structure for the safety valve of FIG. 1.

These drawings and any description herein represent examples that may disclose or explain the invention. The examples include the best mode and enable any person skilled in the art to practice the invention, including making and using any devices or systems and performing any incorporated methods. The drawings are not to scale unless the discussion indicates otherwise. Elements in the examples may appear in one or more of the several views or in combinations of the several views. The drawings may use like reference characters to designate identical or corresponding elements. Methods are exemplary only and may be modified by, for example, reordering, adding, removing, and/or altering individual steps or stages. The specification may identify such stages, as well as any parts, components, elements, or functions, in the singular with the word “a” or “an;” however, this should not exclude plural of any such designation, unless the specification explicitly recites or explains such exclusion. Likewise, any references to “one embodiment” or “one implementation” does not exclude the existence of additional embodiments or implementations that also incorporate the recited features.

### DESCRIPTION

The discussion now turns to describe features of the examples shown in the drawings noted above. These features address material leaks in safety valves that can occur in response to changes in biasing force on the device. These changes may coincide with an increase in system pressure, which is known to reduce or decrease the effective biasing force. This response can allow material to leak as system pressure approaches the set point of the device. Compressible and low-density fluids, like air, can exacerbate these problems, particularly at high temperatures, which can further reduce the density of these fluids. Thermal deflection due to these high temperatures may also make leaks worse because critical parts may deflect or distort. Other embodiments are within the scope of this disclosure.

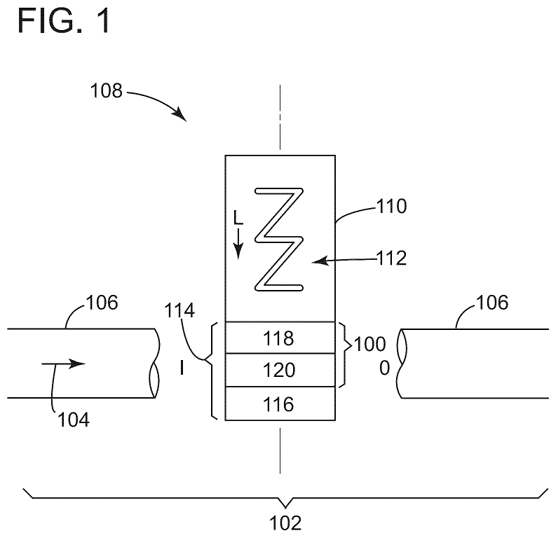

FIG. 1 depicts a schematic diagram of an example of a closure member 100. This example is found in a distribution network 102, typically designed to carry material 104 through a network of conduit 106. The network 102 may include a flow control 108 that has a valve body 110 to connect the device in-line with the conduit 106. The flow control 108 may also have a pre-load unit 112 to generate a load L that regulates flow through a valve 114, for example, the load L may maintain the closure member 100 in contact with a seat member 116. In one implementation, the closure member 100 may include a plug member 118 and a seal member 120.

Broadly, the closure member 100 may be configured to reduce leaks in safety valves. These configurations may improve seat “tightness” at the interface between the closure member 100 and other parts of the valve. This feature may reduce or even eliminate leakage at this interface, which may occur under system pressure at or near the set point for the device.

The distribution system 102 may be configured to deliver or move resources. These configurations may embody vast infrastructure. Material 104 may comprise gases, liquids, solid/liquid mixes, or liquid-gas mixes, as well. The conduit 106 may include pipes or pipelines that may connect to pumps, boilers, and the like. The pipes may also connect to tanks or reservoirs. In many facilities, this equipment forms complex networks.

The flow control 108 may be configured to release pressure in these complex networks. These configurations may include safety valves and like devices. The valve body 110 is often made of cast or machined metals. This structure may form a flange at openings, identified here as “I” and “O.” Adjacent pipes 106 may connect to these flanges. The pre-load unit 112 may include devices that can generate the load L. These devices may store energy, for example, as a result of deflection or like change in length or size. Coiled or compression springs may prevail for this purpose because they may compress or extend in response to changes in system pressure P. Other devices may incorporate pilot valves into the design that use an air supply to maintain the load L as desired.

The valve 114 may be configured to regulate flow of material 104 out of the network 102. These configurations may form a “primary” seal, often a metal-to-metal seal, between the seat 116 and the plug member 118; however, this disclosure contemplates elastomer-to-metal seals or elastomer-to-elastomer seals, as well. The metal-to-metal seal is effective in harsh conditions, for example, in networks that move caustic or hazardous materials or materials at high temperature or high pressure.

The seal member 120 may be configured to prevent leaks of material 104 through the primary seal. These configurations may include devices in position at or near the members 116, 118. These devices may circumscribe all or part of the primary seal, often engaging with both the members 116, 118 to form a “secondary” seal. This feature can capture material 104 inside of the valve 114 to reduce the amount of material 104 that may otherwise leak from the outlet O. In use, each of the seals may both seal and bear load L in response to operating conditions in the valve 114. At no system pressure or low system pressure, for example, the primary seal may perform most, if not all, of the sealing and load-bearing functions. An increase in system pressure, though, may shift one or more of these functions to the secondary seal. In one implementation, construction of the secondary seal may simplify repair and maintenance of the valve, at less costs, because technicians can easily remove and replace it from the device.

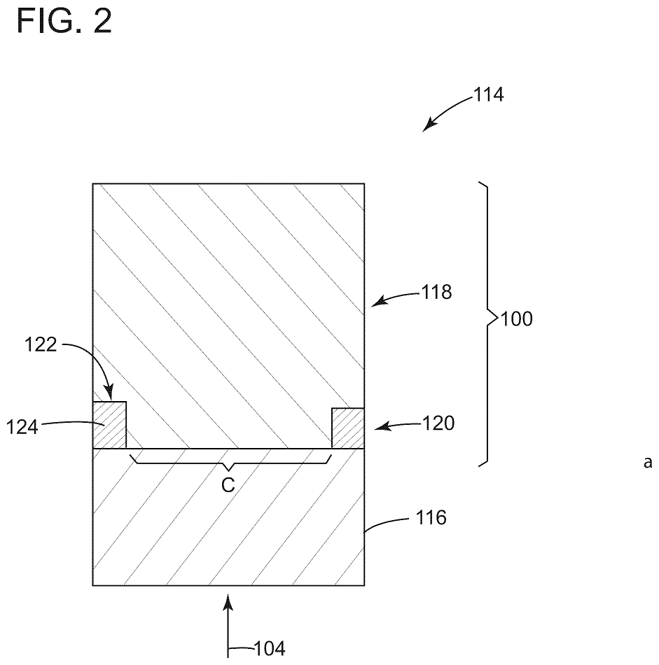

FIG. 2 depicts a schematic diagram of an example of the valve 114 of FIG. 1. This example includes a recess 122, like a groove or cutout, that penetrates the outer surface to reduce the diameter of the plug member 118 at one end. A ring-like or annular device 124 may fit into the recess 122. This “ring” may be configured to fully or partially circumscribe a contact interface C that forms where the plug member 118 contacts the seat 116. The contact interface C may form the primary seal that prevents flow of material 104 through the seat 116. In one implementation, the ring may remain in contact with both the seat 116 and the plug member 118, even if the plug member 118 moves away from or separates from the seat 116, as noted herein. This feature may form the secondary seal that prevents leaks of material 104 until the system pressure causes the valve to fully open to relieve pressure in the network 102.

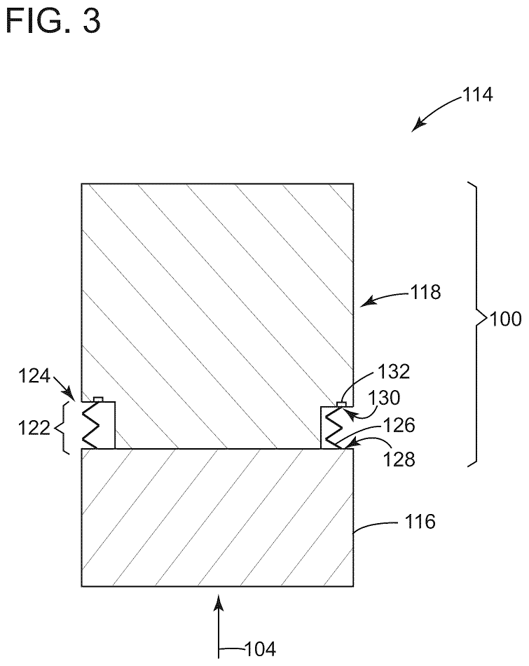

FIG. 3 depicts a schematic diagram of exemplary structure for the annular device 124 of FIG. 2. The structure may include a resilient unit 126 with a body that comprises metal or material that is compatible with conditions that prevail in the network 102 (FIG. 1). The body may adopt geometry that can change configuration in response to presence or absence of the biasing force from the pre-load unit 112 (FIG. 1). Bent or pleated geometry may prevail for this purpose because it may compress to a first configuration in response to the biasing force that causes the plug member 118 to contact the seat 116 and form the contact interface C. In one implementation, the resilient unit 126 may have a first end 128 proximate the seat 116. A second end 130 may couple with the plug member 118. Welds or high strength adhesives might find use for this application; however, other types of fastening techniques may prevail as well. Fasteners may work in conjunction with a channel 132 in the plug member 118 that can receive the second end 130 as well. Use of fasteners (or similar fastening technique) may permit technicians to easily remove and replace the resilient unit 126, if necessary. This feature can reduce costs (in labor and time) for technicians to service or perform maintenance on the flow control 108.

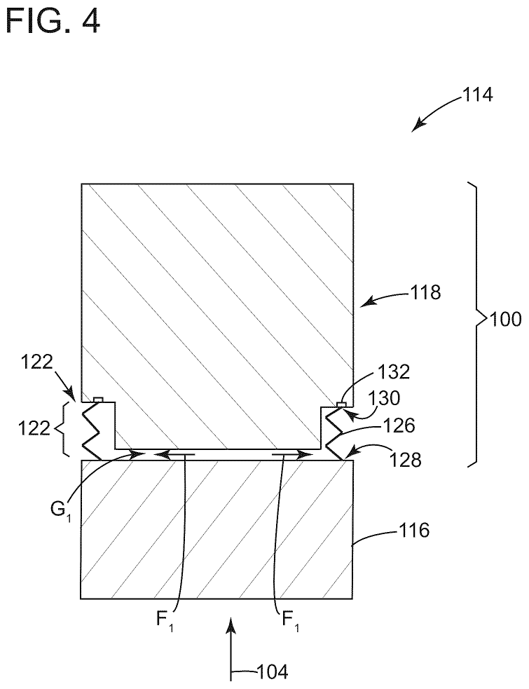

FIG. 4 shows a second configuration for the resilient member 126. In this configuration, the geometry of the body of the resilient member 126 changes concomitantly with the position of the plug member 118 relative to the seat 116. This position may correspond with system pressure that approaches the set point for the flow control 108. In one example, the system pressure may cause the plug member 118 to separate from the seat 116, breaking the primary seal to form a gap G1 (that is typically microscopic in scale). The body of the resilient member 126 may extend or elongate (to the second configuration) to maintain the first end 128 in contact with the seat 116. This feature keeps the secondary seal in place to contain or prevent flow F1 of material 104 from exiting the valve 114. Often, the gap G1 may form under system pressure that is not otherwise meant to actuate the valve 114 to its open position that would allow material 104 to evacuate the device.

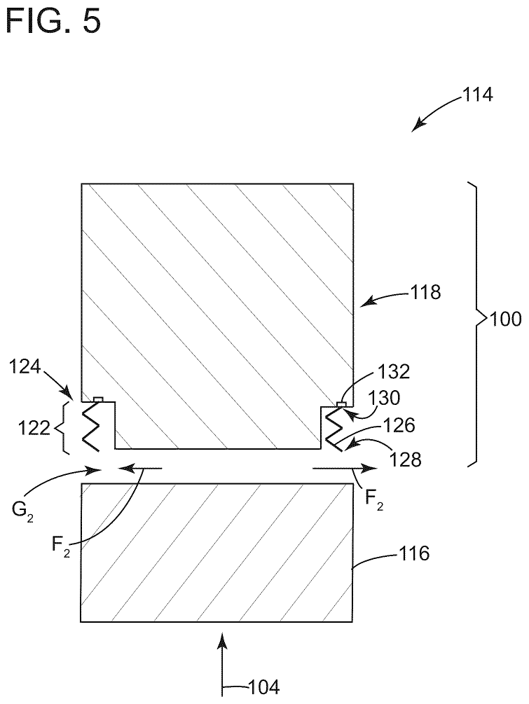

FIG. 5 shows a third configuration for the resilient member 126. This configuration may occur in response to an overpressure condition on the network 102 (FIG. 1). This condition may cause the plug member 118 to separate from the seat 116, forming a gap G2 that is larger than the gap G1 (FIG. 4). The gap G2 may correspond with the open position for the valve 114. In one implementation, the body of resilient member 126 may separate from the seat 116 in the open position for the valve 114. This feature may allow flow F1 of material 104 to evacuate through the valve 114.

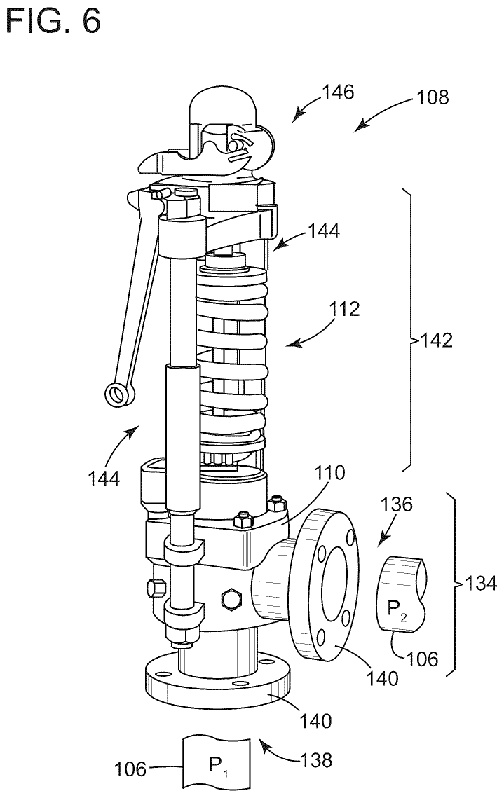

FIG. 6 depicts a perspective view of exemplary structure for the flow control 108. This structure may embody a safety valve. The valve body 110 may form a robust, fluid coupling 134 with a pair of openings (e.g., a first opening 136 and a second opening 138). The fluid coupling 134 may be configured to handle pressure of various fluids, including, for example, steam that is common to nuclear facilities and like power plants. These configurations may have structure, typically of cast, forged, or machined metal, to form a flow path for fluid to flow between pipes P₁, P₂. Flanges 140 (or other joint connections) at the openings 136, 138 may outfit the fluid coupling 134 to couple to pipes P₁, P₂. Fasteners like bolts may be used to ensure secure connection. The structure may also have a bonnet 142 with structural members 144 that attach to the fluid coupling 134. The structural members 144 may be of various construction. A mechanical actuator 146 may reside on top of the bonnet 142. The mechanical actuator 146 may couple with the pre-load unit 112 to pre-load the compression spring.

In view of the foregoing, the improvements herein may reduce leak rates on safety valves. These improvements can prevent leaks of material from the interface between the closure member and the seat until system pressure meets or exceeds the set point (or a pre-determined actuation pressure) for the device. This feature addresses problems with some valves that begin to open in response to system pressure that is around (and often below) this set point. On the other hand, seals consistent with this disclosure can prevent unnecessary escape of materials and are compatible with extreme operating conditions (for example, high temperatures and high pressures,) and caustic materials that foreclose use of more conventional elastomer or “soft” metal material.

The examples below include certain elements or clauses to describe embodiments contemplated within the scope of this specification. These elements may be combined with other elements and clauses to also describe embodiments. This specification may include and contemplate other examples that occur to those skilled in the art. These other examples fall within the scope of the claims, for example, if they have structural elements that do not differ from the literal language of the claims, or if they include equivalent structural elements with insubstantial differences from the literal language of the claims.

What is claimed is:

1. A valve, comprising:
a pre-load unit that is configured to generate a load;
a closure member under influence of the load;
a seat in proximity to the closure member, wherein the closure member and the seat are configured to contact one another to form a primary seal in a closed position; and
a seal member circumscribing the seal to form a secondary seal.

2. The valve of claim 1, wherein the seal member is configured to compress under a load.

3. The valve of claim 1, wherein the seal member is configured extend in absence of a load.

4. The valve of claim 1, wherein the seal member fully circumscribes the primary seal.

5. The valve of claim 1, wherein the seal member remains in contact with the seat when the closure member separates from the seat.

6. The valve of claim 1, wherein the seal member comprises a pleated member.

7. The valve of claim 1, wherein the seal member is attached to the closure member.

8. The valve of claim 1, wherein the seal member is configured to change from a first configuration to a second configuration.

9. The valve of claim 1, wherein the closure member has a recess to receive the seal member.

10. The valve of claim 1, wherein the closure member has a recess with a channel to receive an end of the seal member.

11. A valve, comprising:
a moveable plug;
a stationary seat in proximity to the moveable plug; and
a distal seal disposed between the closure member and the seat,
wherein the distal seal circumscribes a proximate seal made between the closure member and the seat.

12. The valve of claim 11, wherein the distal seal attaches to the moveable plug.

13. The valve of claim 11, wherein the distal seal extends from the moveable plug toward the seat.

14. The valve of claim 11, wherein the distal seal contacts both the moveable plug and the seat when the distal seal is broken.

15. The valve of claim 11, wherein the distal seal moves with the moveable plug.

16. The valve of claim 11, wherein the distal seal comprises a resilient member that elongates in response to movement of the moveable plug.

17. A valve, comprising:
a plug;
a seat; and
an annular ring coupled to the plug, the annular ring circumscribing a portion of the plug that contacts the seat in a closed position to prevent flow of material between the plug and the seat.

18. The valve of claim 17, wherein the annular ring comprises a resilient member having an end affixed to the plug.

19. The valve of claim 17, wherein the annular ring comprises a resilient member having a first end affixed to the plug and a second end in contact with the seat in the closed position.

20. The valve of claim 17, wherein the annular ring comprises a resilient member having a first end affixed to the plug and a second end in contact with the seat in the closed position and a partially-opened position where the plug is spaced apart from the seat.
